(19) United States
(12) Patent Application Publication
(10) Pub. No.: US 2005/0184486 A1
(43) Pub. Date: Aug. 25, 2005

(54) Gas bag module

(75) Inventors: Michael Schneider, Sulzbach (DE); Constantin Hauer, Schoellkrippen (DE); Alexander Limberger, Main (DE); Alfred Scheuermann, Wald-Michelbach (DE)

Correspondence Address: TAROLLI, SUNDHEIM, COVELL, & TUMMINO L.L.P., 1111 LEADER BLDG., 526 SUPERIOR AVENUE, CLEVELAND, OH, 44114-1400, US

(73) Assignee: TRW Automotive Safety Systems GmbH

(21) Appl. No.: 11/061,216

(22) Filed: Feb. 18, 2005

(30) Foreign Application Priority Data
Feb. 20, 2004 (DE) 20 2004 002 698.8

(51) Int. Cl. B60R 21/20; B60R 21/16

(52) U.S. Cl. 280/728.2; 280/731; 280/728.3

(57) ABSTRACT

A gas bag module includes a covering cap (10), an annular space (34) lying beneath the covering cap (10) and a gas bag (36) housed in the annular space (34) with a ring-shaped chamber (40) extended around an indentation (38) which is not inflated. The indentation (38) is formed in that a clamping section (44) of the gas bag wall, which is spaced apart from an inflation opening of the gas bag (36), is permanently fastened to an end wall (24), close to the covering cap (10), of one of a diffusor cage (18) and a gas generator (16). The covering cap (10) has a cap centre (52) permanently fastened to the end wall (24), which in an opened state of the gas bag module is surrounded by a ring-shaped outlet opening (60). A spacer, provided as a separate part, is arranged beneath the covering cap (10) and above the end wall (24). The spacer fixes the clamping section (44) of the gas bag (36). The spacer is arranged on the end wall (24) by fastening means (28) and prevents the folded gas bag (36) from projecting into a volume between the end wall (24) and a central cap section lying above the end wall (24).

### TECHNICAL FIELD

The invention relates to a gas bag module with a ring-shaped gas chamber.

### BACKGROUND OF THE INVENTION

A ring-shaped gas bag is known for example from DE 202 22 019 or DE 197 49 914 C2. In these gas bags, usually a centre section of the gas bag front wall is retained in the module, so that, as seen from the point of view of the occupant, an indentation results.

It is an object of the invention to secure the position of the gas bag in the folded state in the annular space provided for this in the module and to prevent a slipping of folded fabric layers, so that the unfolding process can take place unobstructed.

### BRIEF SUMMARY OF THE INVENTION

This is achieved by a gas bag module according to the present invention comprising a covering cap, an annular space lying beneath the covering cap and a gas bag housed in the annular space with a ring-shaped chamber extended around an indentation which is not inflated. The indentation is formed in that a clamping section of the gas bag wall, which is spaced apart from an inflation opening of the gas bag, is permanently fastened to an end wall, close to the covering cap, of one of a diffusor cage and a gas generator. The covering cap has a cap centre permanently fastened to the end wall, which in an opened state of the gas bag module is surrounded by a ring-shaped outlet opening. A spacer, provided as a separate part, is arranged beneath the covering cap and above the end wall. The spacer fixes the clamping section of the gas bag. The spacer is arranged on the end wall by fastening means and prevents the folded gas bag from projecting into a volume between the end wall and a central cap section lying above the end wall.

As said before, the spacer is provided as a separate part and can be releasably connected to the cap covering.

The invention ensures that only the one fabric layer of the gas bag, which represents the clamping section, comes to lie between the end wall and the covering cap and is clamped there. Thereby, the gas bag unfolding is able to be controlled very well, and a clamping of an individual fabric layer in the intermediate space between the end wall and the covering cap can be prevented without additional means.

The great advantage of the invention also consists in that the gas bag does not have to be folded into the cup-shaped covering cap. The folding of the gas bag can take place outside the covering cap. The spacer delimits the gas bag package radially inwards, until finally the covering cap is placed onto the package together with diffusor cage or gas generator and is fastened to the diffusor cage or to the gas generator.

The spacer preferably has an underside parallel to the end wall, so that the clamping section is clamped over a large area between two surfaces. Furthermore, no gap results between end wall and spacer.

Preferably, the spacer is a cup-shaped part which is upwardly open, with a base and a peripheral wall projecting upwards from the base. This solution permits a compact embodiment in axial direction (gas bag outlet direction), because the covering cap is usually provided with an emblem in its cap centre and is relatively thick in this region. Therefore, this thicker cap centre can be largely held in the cup, it projects into the cup and lies against the base.

Furthermore, the peripheral wall has an upper edge, and the upper edge of the peripheral wall of the cup-shaped part lies against the underside of the covering cap, so that no gap occurs here between these parts.

The cap centre is preferably arrested on the end wall by means of a separate fastening element. The diffusor cage or the gas generator together with the cup form one unit which is pre-assembled by its own fastening means, so that this connection no longer has to be loosened when the covering cap is later arrested by means of its own fastening means on the end wall. Thereby, also, gas bag fabric material can no longer move between spacer and diffusor.

The diffusor cage or the gas generator are to be arranged inside the gas bag. The diffusor cage in this case forms the gas bag holding part which fixes the gas bag in the region of the inflation opening.

The spacer can also assume another further important function. If the ring-shaped outlet opening is provided with a different radial width over the periphery, then it could lead to a highly unsymmetrical outlet behaviour of the gas bag and to an unsymmetrical opening behaviour of the covering cap. The spacer is then able to prevent or reduce this unsymmetrical unfolding behaviour or opening behaviour, by being arranged unsymmetrically so that it projects further into the wider region of the outlet opening than in a narrow region. Here, the spacer acts as a kind of barrier in outlet direction of the gas bag in front of the outlet opening.

The spacer can also have an unsymmetrical outer contour and/or project for example partially laterally beyond the end wall.

### BRIEF DESCRIPTION OF THE DRAWINGS

FIG. 1 shows a sectional view through the gas bag module according to the invention, and

FIG. 2 shows a perspective view of a spacer used in the gas bag module according to the invention.

### BRIEF DESCRIPTION OF THE PREFERRED EMBODIMENT

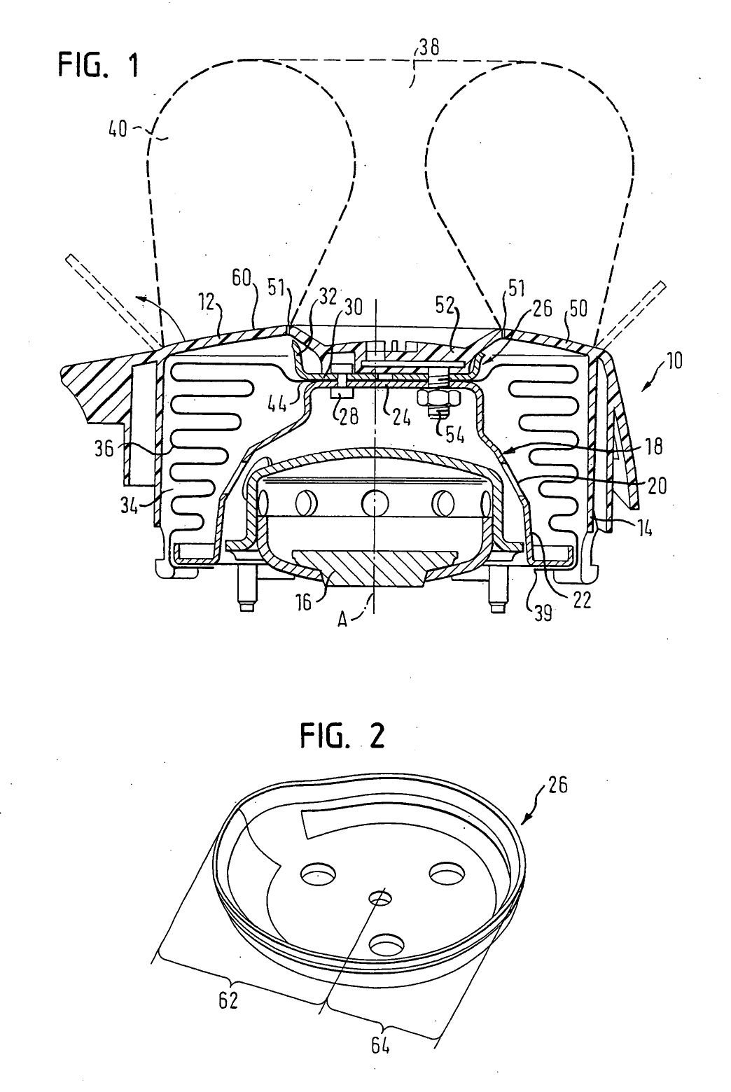

In FIG. 1 a gas bag module is shown, which has a cup-shaped covering cap 10 with a front wall 12 and a peripheral wall 14. The gas bag module further comprises a gas generator 16, projecting into the covering cap 10, which is surrounded by a diffusor cage 18, so that between gas generator 16 and diffusor cage 18 a diffusor space is formed. The diffusor cage 18 has radial outflow openings 20 on its peripheral wall 22 and also a flat end wall 24 directed to the front wall of the covering cap 10. A spacer in the form of a cup-shaped part 26 is fastened by its own fastening means 28 (e.g. rivets, screws and the like) to the end wall 24. The cup-shaped part 26 has a flat base 30, which runs parallel to the end wall 24, and a cylindrical peripheral wall 32 projecting upwards therefrom.

Between the peripheral wall 14 of the covering cap 10 and the peripheral wall 22 of the diffusor cage 18 and also the cup-shaped part 26, an annular space 34 is delimited, lying under the front wall 12, for housing a gas bag 36. The gas bag 36 is clamped by the diffusor cage 18 in the region of its opening edge 39, defining the inflation opening, against a housing part which is not shown. In the inflated state (illustrated with broken lines), the gas bag 36 has an annular shape with a ring-shaped chamber 40, which has an indentation 38 originating from the front, which is formed in that a central section of the gas bag wall is prevented from a free movement outwards. This central section is designated as clamping section 44. The clamping section 44 lies between the base 30 of the cup-shaped part 26 and the end wall 24 and is clamped between these two parts over a large area.

The front wall 12 of the covering cap 10 has a flap section 50. The flap section 50 is delimited on the inner side by a tear line 51 and surrounds a covering cap centre 52, which is fastened by means of its own fastening elements 54 (e.g. screw-nut-connections) permanently on the end wall 24. The cap centre 52 forms a depression of the covering cap 10, in which usually an emblem lies, and projects into the interior of the cup-shaped part 26 which is open from above. The cap centre 52 is pressed with its full surface against the base 30.

As FIG. 1 shows, the upper edge of the peripheral wall 32 lies against the underside of the covering cap 10, so that the entire volume defined between the end wall 24 and the central cap section lying thereabove is closed and no gas bag material can project into this region. The central cap section lying over the end wall 24 is the region of the covering cap 10 which is defined by axial projection (axial with respect to the central line A of the gas bag module) of the end wall 24 onto the cap 10.

The covering cap 10 covers a ring-shaped outlet opening 60 for the gas bag 36. This outlet opening 60 has wide regions which are different radially in top view. As can be seen in FIG. 1, the left-hand region of the outlet opening 60 is distinctly wider than the right-hand region of the outlet opening 60.

So that no unsymmetrical opening behaviour of the covering cap 10 and also no unfolding behaviour of the gas bag 36 of different intensity results in these regions of different width, the cup-shaped part 26 is constructed and/or arranged unsymmetrically with respect to the central axis A so that a wider region 62 and a narrower region 64 are produced. The wider region 62 projects, as can be seen in FIG. 1, laterally beyond the end wall 24 and represents a barrier situated in outlet direction of the gas bag 36 in front of the outlet opening 60, which reduces the effective area later available for the outlet. In contrast to this, the cup-shape part 26 in the region 64 at the right-hand end of the end wall 24 closes off almost flush therewith and in no way constricts the channel available for the emergence of the gas bag 36.

As can also be seen from FIG. 1, the end wall 24, which is constructed in a circular shape, is arranged staggered radially to the central axis A, so that the annular space 34 on the left-hand half of FIG. 1 also has a greater radial width than on the right-hand half. Thereby, the outlet behaviour can be influenced purposefully, if the aim, for example, is to allow the gas bag 36 to emerge firstly in the lower or in the upper region.

The module is mounted as follows. Firstly, the diffusor cage 18 is inserted into the gas bag 36. Then the cup-shaped part 26 is connected with the end wall 24 by means of the fastening means 28. This connection can take place before or after the folding of the gas bag 36. The folding of the gas bag 36 takes place in a device which has a peripheral wall which imitates the peripheral wall 14. The gas bag package which is formed is fixed for example by means of a foil or the like. The gas bag package here does not project upwards with respect to the peripheral wall 32 of the cup-shaped part 26. Then the unit of folded gas bag 36, diffusor cage 18 and cup-shaped part 26 is inserted into the covering cap 10 and the cap centre 52 is fastened on the end wall 24 with projecting screw bolts integrated on the rear side. Finally, the gas bag 36 is introduced from the rear into the diffusor cage 18.

It is to be stressed that alternatively also, the diffusor cage 18 can be omitted, so that the gas generator 16 can take the place of the diffusor cage 18. The cup-shaped part 26 is then placed against the end wall of the housing of the gas generator 16 on the upper side. Here, of course, a small intermediate part could possibly also be provided. As the gas generator 16 of course is not available for a penetration of a rivet or a screw, like the diffusor cage 18, welded-on screw bolts could project upwards from the gas generator 16, which serve for fastening the cup-shaped part 26 and/or the cap centre 52.

1. A gas bag module comprising:
a covering cap (10),
an annular space (34) lying beneath said covering cap (10),
a gas bag (36) housed in said annular space (34) with a ring-shaped chamber (40) which extends around an indentation (38) which is not inflated, said indentation (38) being formed in that a clamping section (44) of said gas bag wall, which is spaced apart from an inflation opening of said gas bag (36), is permanently fastened to an end wall (24), close to said covering cap (10), of one of a diffusor cage (18) and a gas generator (16),
said covering cap (10) having a cap centre (52) permanently fastened to said end wall (24), which in an opened state of said gas bag module is surrounded by a ring-shaped outlet opening (60),
and a spacer, provided as a separate part, arranged beneath said covering cap (10) and above said end wall (24) and fixing said clamping section (44) of said gas bag (36),
said spacer being arranged on said end wall (24) by fastening means (28) and preventing said folded gas bag (36) from projecting into a volume between said end wall (24) and a central cap section lying above said end wall (24).

2. The gas bag module according to claim 1, wherein said spacer has an underside parallel to said end wall (24).

3. The gas bag module according to claim 1, wherein said spacer is a cup-shaped part (26) which is upwardly open, with a base (30) and a peripheral wall (32) projecting upwards from said base (30).

4. The gas bag module according to claim 3, wherein said central cap section lying over said cup-shaped part (26) projects into said cup-shaped part (26) and lies against said base (30).

5. The bas bag module according to claim 3, wherein said peripheral wall (32) has an upper edge, said upper edge of said peripheral wall (32) lying against said underside of said covering cap (10).

6. The gas bag module according to claim 1, wherein said cap centre (52) is arrested on said end wall (24) by means of a separate fastening element (54).

7. The gas bag module according to claim 1, wherein said diffusor cage (18) is arranged inside said gas bag (36).

8. The gas bag module according to claim 1, wherein said ring-shaped outlet opening (60) has regions with different radial width and that said spacer is one of constructed and arranged symmetrically so that it projects laterally further into a wider region (62) than into a narrow region (64).

9. The gas bag module according to claim 8, wherein said spacer has an unsymmetrical outer contour.

10. The gas bag module according to claim 1, wherein said spacer projects partially laterally beyond said end wall (24).

11. The gas bag module according to claim 1, wherein in said region of said spacer, said gas bag (36) in the folded state does not project beyond said spacer in the direction towards said covering cap (10).
